(19) United States
(12) Patent Application Publication
(10) Pub. No.: US 2002/0005425 A1
(43) Pub. Date: Jan. 17, 2002

(54) Devices for opening at least one wrapper in which coins are wrapped

(76) Inventors: Wilhelmus Martinus Anthonius Kusters, Venlo (NL); Mathijs Henricus Johannes Quicken, Tegelen (NL); Anthonius Petrus Johannes Stefanus Leenen, Well (NL)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/737,921

(22) Filed: Dec. 15, 2000

(30) Foreign Application Priority Data
Dec. 17, 1999 (NL) 1013881

(51) Int. Cl. B26F 3/00

(52) U.S. Cl. 225/97; 225/103

(57) ABSTRACT

A device suitable for opening at least one wrapper in which coins are wrapped, which devices comprise a drum which is capable of rotation about a central axis, the cylindrical drum wall of which is provided with wrapper breaking elements extending towards said central axis, as well as with coin passages. The device furthermore comprises a suction device for extracting opened wrappers and remaining wrapper parts.

The wrapper breaking elements comprise spaced-apart bars extending substantially parallel to each other, with the coin passages being present between said bars.

The suction device extends into the interior of the drum through an axial opening bounded by the cylindrical drum wall.

The invention relates to devices suitable for opening at least one wrapper in which coins are wrapped, which devices comprise a drum which is capable of rotation about a central axis, the cylindrical drum wall of which is provided with wrapper breaking elements extending towards said central axis, as well as with coin passages, which devices furthermore comprise a suction device for extracting opened wrappers and remaining wrapper parts.

When coins are to be transported, said coins are wrapped in paper wrappers or plastic bags, for example. In this way the coins are easy to distribute and to count. Also large shops such as supermarkets and department stores often have machines for wrapping coins in wrappers or bags in order for the coins to be transported to a bank of be delivered to the cash desks in the shops again.

At a cash desk the wrappers or bags will be opened manually, after which the coins can be put away in the cash desk.

At a bank the wrappers or bags presented there will have to be opened as well in order to verify whether the wrappers indeed contain the number of coins of a specific value that is indicated thereon. Subsequently the coins are wrapped again by the banks.

The opening of the wrappers can take place manually or by machine. If it is desired to open wrappers by machine, it is for example possible to use a device known from U.S. Pat. No. 5,964,388, to which wrappers are fed one by one, which wrappers are subsequently opened one by one.

A device of this kind is in particular suitable when a relatively small number of wrappers is to be opened. When larger numbers of wrappers are to be opened, the use of such a device is relatively time-consuming. The opening of a relatively large number of wrappers may also be necessary if the coins wrapped therein are to be destroyed, for example by means of a device known from international patent application WO 99/52638.

A device as referred to in the Introduction is known from British patent application GB-A-2,028,255. In this device the wrapper breaking elements comprise blades connected to the drum wall. The drum is slightly inclined, as a result of which the wrappers, which have been opened in the meantime, are carried to the lowermost point of the drum. Said lowermost point of the drum is provided with radially extending openings, through which the coins that have been removed from the wrappers as well as the remaining wrapper parts are discharged.

One drawback of this prior art device is the fact that the opening of the wrappers and the subsequently separate discharging of the wrappers and the coins that have been removed therefrom are both relatively complicated operations.

Consequently it is an object of the invention to provide devices by means of which coins can be removed from wrappers and be separated from said wrappers relatively quickly.

This objective is accomplished with the device according to the invention in that said wrapper breaking elements comprise spaced-apart bars extending substantially parallel to each other, with the coin passages being present between said bars.

The bars, which extend in axially or radially parallel relationship to each other, make it possible to provide the entire drum wall both with roll breaking elements and with coin passages in a relatively simple manner.

The above objective is accomplished with another device according to the invention in that said suction device extends into the interior of the drum through an axial opening bounded by the cylindrical drum wall.

As a result of this arrangement, the empty wrappers or remaining wrapper parts can be removed from the interior in a simple manner whilst the drum can rotate without impediment.

The wrappers are carried up by the rotating drum wall, and they fall down again under the influence of the force of gravity. The wrappers thereby land on the bar-shaped wrapper breaking elements, whereby the wrappers are damaged by the wrapper breaking elements. After a wrapper has landed “on” a wrapper breaking element one or more times, the wrapper will break and the coins will wrapper out of the wrapper. A wrapper part in which coins are still present will be carried up by the drum wall again, and it will fall down again under the influence of the force of gravity. As a result of these movements, also the remaining coins will fall out of said wrapper part. Then the relatively heavy coins will fall through the coin passages in the drum wall under the influence of the force of gravity, whereupon they can be discharged. The wrappers or remaining wrapper parts, from which the coins have been removed, are relatively light in weight, and they can readily be extracted from the interior of the drum by suction.

In this way it is possible to open a large number of wrappers substantially simultaneously, after which the coins and the empty wrappers are discharged separately.

It is noted that German patent application DE-A1-43.23.386 discloses a drum built up of bars, which is used in a device for opening refuse bags. Said device does not include separate means for opening the bags, however. The bars merely function as passages In addition, the device disclosed therein does not include a suction device for the opened packages.

The invention will now be explained in more detail with reference to the drawings, wherein:

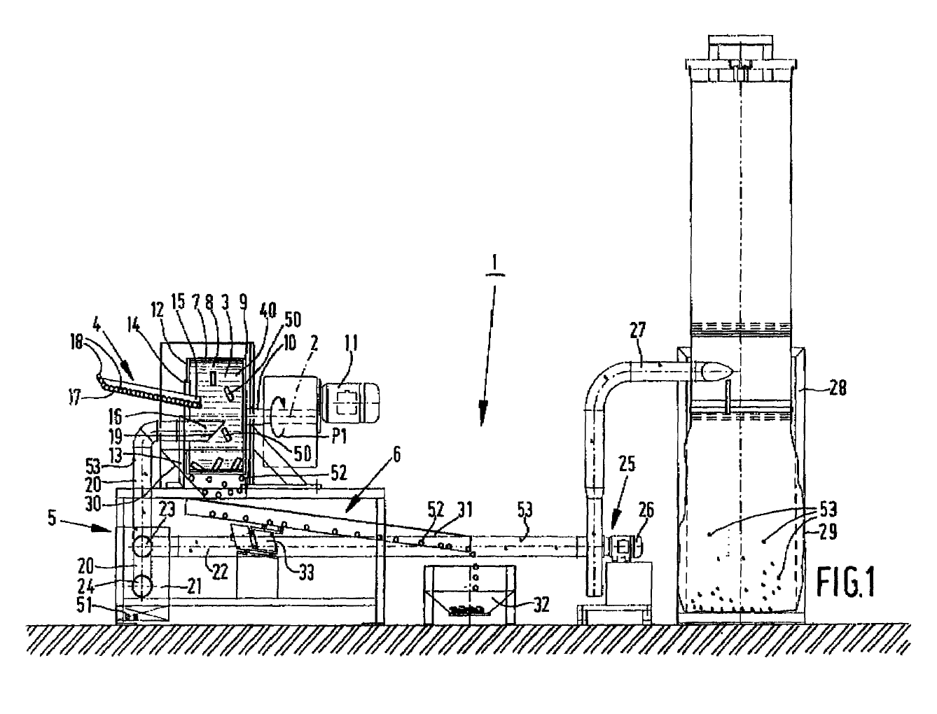

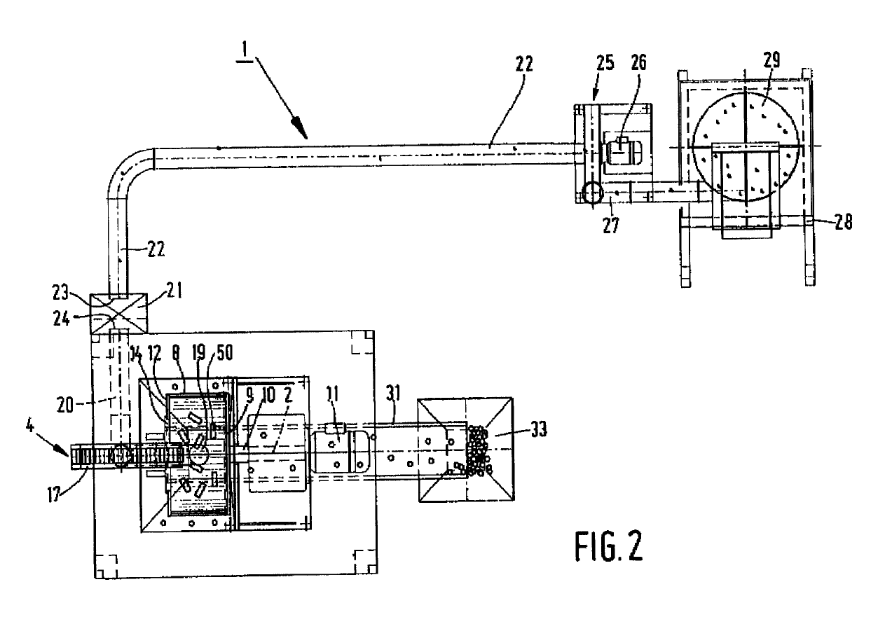

FIGS. 1-3 are a side view, a top plan view, and a front view, respectively, of a device according to the invention;

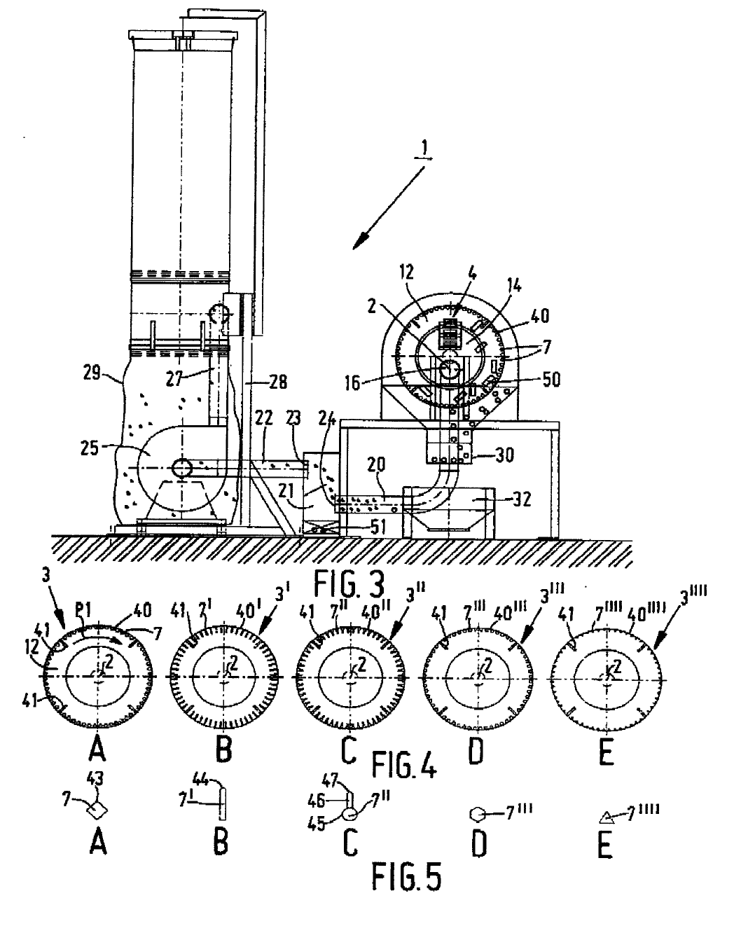

FIGS. 4A-4E show different embodiments of drums of the device that is shown in FIGS. 1-3; and

FIGS. 5A-5E are cross-sectional views of bars of the drums shown in FIGS. 4A-4E, respectively.

Parts corresponding to each other are indicated by the same numerals in the figures.

FIGS. 1-3 are a side view, a top plan view, and a front view, respectively, of a device 1 according to the invention, which comprises a drum 3, which is capable of rotation about a central axis 2, a coin wrapper feeder 4 connected thereto, a wrapper discharger 5 and a coin discharger 6. The wrapper may be a roll, a bag, etc. In the illustrated embodiment the wrapper is a roll.

Drum 3 comprises a drum wall B built up of bars 7, which is connected to a disc-shaped plate 9 on one side. The bars 7 of the drum wall 8 will be explained in more detail yet with reference to FIGS. 4A-5E. The plate 9 is connected, on a side remote from drum wall a, to a shaft 10 extending parallel to central axis 2, which shaft is driven by means of a motor 11. Drum wall 8 is connected, on a side remote from disc 9, to an annular disc 12. Annular disc 12 is capable of rotation in a plate 14 that is connected to frame 13.

Two openings are formed in plate 14, through which, respectively, one end 15 of coin roll feeder 4 and a mouthpiece 16 of roll discharger 5 extend.

Coin roll feeder 4 has a sliding surface 17 that slopes down towards the interior of the drum 3, over which the coin rolls 18 slide towards the interior of drum 3 under the influence of the force of gravity.

Roll discharger 5 comprises the mouthpiece 16, which is provided with an oblique opening 19. Mouthpiece 16 is preferably positioned under the horizontally extending central axis 2, so that it is located relatively close to the lowest part of drum wall 8.

Mouthpiece 16 is connected, via a tube 20, to a collecting chamber 21 for coins that have remained behind in rolls. Connected to collecting chamber 21 is a discharge tube 22, the end 23 of which is disposed in collecting chamber 21 and positioned above the end 24 of tube 20.

Tube 22 is connected, on a side remote from collecting chamber 21, to a suction and blowing device 25, which is driven by means of a motor 26. A pipe 27 is disposed on the blowing side of the suction and blowing device 25, which pipe opens above a bag 29 that is disposed in a holder 28.

Coin discharger 6 comprises a coin receptacle 30 surrounding the lower part of drum 3, which opens above a vibrating trough 31 on a side remote from central axis 2. Vibrating trough 31 extends downwards from receptacle 30 towards a coin collecting container 32. Vibrating trough 31 is driven by means of a vibrating mechanism.

Before the operation of the device shown in FIGS. 1-3 is explained in more detail, the drum 3 will first be described in more detail with reference to FIGS. 4A-5E.

FIGS. 4A and 5A are a cross-sectional view of drum 3 and a cross-sectional view of a bar 7, respectively.

Bars 7 extend parallel to each other and to central axis 2, and they are connected to plates 7 and 12 near their ends. Bars 7 are spaced apart by such a distance that a coin roll that is still intact cannot fall therethrough, whilst a coin that has been removed from a coin roll can readily pass through the coin passages 40 that are located between the bars 7. This means that the spacing between the bars 7 must be smaller than the diameter of the roll and larger than the thickness of a single coin. Drum 3 furthermore includes four strips 41 extending parallel to the bars, whose ends 42 are disposed closer to central axis 2 than bars 7. In the embodiment of drum 3 that is shown in FIG. 4A, the bars 7 are of square cross-section, as can be seen in FIG. 5A, with a corner point 43 of bar 7 extending towards central axis 2.

FIGS. 4B-5E show four other embodiments of drums 3′-3″″, which differ from drum 3 in that the shape of the bars 7-7″″ and, consequently, the shape of coin passages 40′-40″″ is different therefrom.

In the embodiment that is shown in FIGS. 4B and 5B, the bars 7′ are strip-shaped, with one end facing towards central axis 2 having a sharp point 44.

In the embodiment that is shown in FIGS. 4C and 5C, bar 7″ comprises a metal pin 45, to which a strip 46 is attached. Strip 46 has a sharp edge 47 on a side facing towards central axis 2.

In the embodiment that is shown in FIGS. 4D and 5D, bar 7′41 is of hexagonal cross-section, with one corner facing towards central axis 2.

In the embodiment that is shown in FIGS. 4E and 5E, strip 7″″ is of triangular cross-section, with one corner facing towards central axis 2.

It is also possible to use mutually different bars 7-7″″ in a drum, of course.

The operation of the device 1 will now be explained in more detail. Coins wrapped in rolls 50 are moved to the interior of drum 3, via chute 17, by means of coin roll feeder 4. The coin rolls 50 will fall downwards under the influence of the force of gravity and land on edges 43 of bars 7. As a result of this, coin rolls 50 undergo first damaging. Drum 3 is rotated about central axis 2 in the direction indicated by arrow P1 by means of motor 11. As a result of this rotation, rolls 50 are carried along by bars 7 and roll carrier strips 42 and likewise rotated in the direction indicated by arrow P1. During the movement of rolls 50 in the direction indicated by arrow P1, rolls 50 grate along the edges 43 of bars 7 and along each other. In addition, after having been moved some distance in the direction indicated by arrow P1, rolls 50 will fall downwards again under the influence of the force of gravity and land on the edges 43 of bars 7 again. As a result of these continuously repeated movements the rolls, for example comprising a paper wrapper, are damaged, causing them to break open. Coins 52 will fall out of the rolls thereby and exit drum 3 via coin passages 40. Coins 52 are caught in receptacle 30 under drum 3, and carried to coin collecting container 32 via vibrating trough 31. When coins are still present in a remaining roll part, contact with bars 7 and the other rolls 50 will cause them to fall out of said remaining part. As soon as the coins have moved, slid or vibrated out of the rolls or the remaining roll parts, the remaining roll parts 53 are relatively light in weight and they can easily be extracted by suction through the mouthpiece 16 with the downwardly inclined opening 19 that is located near the lower part of the drum 3, and be introduced into tube 20. In addition, the empty rolls and remaining roll parts are carried up by the drum wall again, and subsequently they flutter downwards, whereby they are extracted through mouthpiece 16. Tube 20 guides the empty rolls and remaining roll parts to collecting chamber 21. If a single coin is still present in the broken rolls 53 or remaining roll parts 53, the weight of the roll in question will thus be relatively high. Consequently, such a coin, which is still partially wrapped, will fall to the bottom of the collecting chamber 21 together with the paper still enveloping the coin, and stay there, after which it can be manually removed yet. The rolls or remaining roll parts 53, from which the coins have been completely removed, are sucked into tube 22 by suction device 25, after which they are blown to bag 29 via tube 27.

In this manner a large number of coin rolls can be opened in a relatively short period of time by the drum 3, which is provided with roll breaking elements and coin passages, and subsequently be separated into rolls or remaining roll parts on the one hand and coins on the other hand.

By means of drums 3′-3″″ rolls can be opened and separated in a similar manner. The selection of the cross-sectional configuration of the bars 7, the dimension thereof and the dimension of the coin passages 40 depend, among other things, on the size of the coins that are to be handled in drum 3 as well as on the type of material (paper, plastic, etc.) from which the rolls is made.

It is also possible to have the bars 7 extend radially or at an angle to central axis 2.

It is also possible to provide the drum wall with a bar-shaped pattern of holes, such as circular holes, oval slits, slots, etc., through which coins can fall, and with pins, knives, etc.

It is also possible to give the opening 19 a rectangular or other shape.

It is also possible to make the bars round.

It is also possible to dispose the mouthpiece 16 slidably in the drum so that the mouthpiece can be adjusted in dependence on the rolls or remaining roll parts that are to be extracted.

1. A device suitable for opening at least one wrapper in which coins are wrapped, which device comprises a drum which is capable of rotation about a central axis, the cylindrical drum wall of which is provided with wrapper breaking elements extending towards said central axis, as well as with coin passages, which device furthermore comprises a suction device for extracting opened wrappers and remaining wrapper parts, characterized in that said wrapper breaking elements comprise spaced-apart bars extending substantially parallel to each other, with the coin passages being present between said bars.

2. A device according to claim 1, characterized in that said suction device extends into the interior of the drum through an axial opening bounded by the cylindrical drum wall.

3. A device suitable for opening at least one wrapper in which coins are wrapped, which devices comprise a drum which is capable of rotation about a central axis, the cylindrical drum wall of which is provided with wrapper breaking elements extending towards said central axis, as well as with coin passages, which devices furthermore comprise a suction device for extracting opened wrappers and remaining wrapper parts, characterized in that said suction device extends into the interior of the drum through an axial opening bounded by the cylindrical drum wall.

4. A device according to claim 3, characterized in that the wrapper breaking elements comprise spaced-apart bars extending substantially parallel to each other, with the coin passages being present between said bars.

5. A device according to claim 1, 2 or 4, characterized in that said bars extend substantially parallel to the central axis of the drum.

6. A device according to claim 1, 2 or 4, characterized in that said bars are of polygonal cross-section.

7. A device according to claims 1 or 3, characterized in that the device furthermore includes at least one wrapper carrier disposed inside the drum.

8. A device according to claim 7, characterized in that said wrapper carrier comprises at least one substantially radially and axially extending strip.

9. A device according to claims 1 or 3, characterized in that said suction device comprises a mouthpiece which is disposed in the interior of the drum.

10. A device according to claim 9, characterized in that said mouthpiece extends at least partially towards the coin outlet openings.

11. A device according to claims 1 or 3, characterized in that said device comprises a wrapper feeder, one end of which is disposed in the interior of the drum.

12. A device according to claim 11, characterized in that said wrapper feeder extends into the interior of the drum through an axial opening bounded by the cylindrical drum wall.

13. A device according to claim 9, characterized in that the drum is capable of rotation about a stationary feed flange, through which the the mouthpiece extend.

14. A device according to claim 11, characterized in that the drum is capable of rotation about a stationary feed flange, through which the wrapper feeder extend.
